(19) United States
(12) Patent Application Publication
(10) Pub. No.: US 2008/0236259 A1
(43) Pub. Date: Oct. 2, 2008

(54) Method of Control of Probe Scan and Apparatus for Controlling Probe Scan of Scanning Probe Microscope

(76) Inventors: Tooru Kurenuma, Ibaraki (JP); Yukio Kenbou, Ibaraki (JP); Hiroaki Yanagimoto, Ibaraki (JP); Hiroshi Kuroda, Ibaraki (JP); Takafumi Morimoto, Ibaraki (JP)

Correspondence Address: MATTINGLY, STANGER & MALUR, P.C., 104 East Hume Avenue, Alexandria, VA, 22301, US

(21) Appl. No.: 11/660,271

(22) PCT Filed: Aug. 18, 2005
(86) PCT No.: PCT/JP2005/015057

§ 371 Date: Jan. 9, 2008

(30) Foreign Application Priority Data
Aug. 18, 2004 (JP) 2004-238374
Feb. 28, 2005 (JP) 2005-053421

(51) Int. Cl. G01B 5/28

(52) U.S. Cl. 73/105

(57) ABSTRACT

A scanning probe microscope provided with a cantilever 21 having a probe 20 facing a sample 12, a measurement unit 24 measuring a physical quantity occurring between the probe and sample, and movement mechanisms 11, 29 changing a positional relationship between the probe and sample to cause a scanning operation and making the probe scan the surface of the sample by the movement mechanism and measure the surface of the sample by the measurement unit. This method is provided with a step of feeding the probe in a direction along the surface of the sample at a position separate from the surface at certain distances, a step of making the probe approach the sample at each of a plurality of measurement points determined at certain distances and perform measurement to obtain measurement values, then retract, and a step setting a measurement point at a position between a certain measurement point and next measurement point for measurement when a difference between a measurement value at the certain measurement point and a measurement value at the next measurement point is larger than a reference value.

### TECHNICAL FIELD

The present invention relates to a method of control of a probe scan of a scanning probe microscope and an apparatus for controlling a probe scan, more particularly relates to a method and apparatus for control of a probe scan suitable for quick and accurate measurement of relief shapes of a sample surface by a scanning probe microscope.

### BACKGROUND ART

A scanning probe microscope has long been known as a measurement device with a measurement resolution enabling observation of fine objects of the atom order or size. In recent years, scanning probe microscopes have been applied to a variety of fields such measurement of the fine relief or uneven shapes of the surface of a substrate or wafer on which semiconductor devices are formed. There are various types of scanning probe microscopes designed for different physical quantities for detection utilized for measurement. For example, there are scanning tunnel microscopes (STM) utilizing the tunnel current, atomic force microscopes (AFM) utilizing atomic force, magnetic force microscopes (MFM) utilizing magnetic force, etc. The range of their application is also growing.

Among the above, atomic force microscopes are suitable for detecting the fine relief shapes of a sample surface at a high resolution and are proving themselves in the fields of semiconductor substrates, disks, etc. Recently, they are also being used for applications of in-line automatic inspection processes.

An atomic force microscope is provided with a measurement part using the principle of atomic force microscopes to form the basic configuration of a measurement device. Usually, it is provided with a tripod type or tube type XYZ fine movement mechanism formed using a piezoelectric element. At the bottom end of this XYZ fine movement mechanism, a cantilever with a probe formed at its front end is attached. The front end of the probe faces the surface of the sample. The above cantilever is provided with for example an optical lever type photo detection device. That is, a laser beam emitted from a laser beam source (laser oscillator) provided above a cantilever is reflected at the back surface of the cantilever and detected by a photo detector. If twisting or bending occurs in the cantilever, the position on the light receiving surface of the photo detector (for example, four-part light receiving surface) which the laser beam strikes will change. Therefore, if displacement occurs at the probe and cantilever, it is possible to detect the direction and amount of the displacement by the detection signal output from the photo detector. Regarding the configuration of the above atomic force microscope, it is normally provided with a comparator and controller as a control system. The comparator compares the detection voltage signal output from the photo detector and the reference voltage and outputs an error signal. The controller generates a control signal so that the error signal becomes 0 and gives this control signal to the Z-fine movement mechanism in the XYZ fine movement mechanism. In this way, a feedback servo control system for maintaining the distance between the sample and the probe at a certain distance is formed. Due to the above configuration, the probe can be made to follow along and scan fine relief shapes on the sample surface and measure the shapes.

At the time when the atomic force microscopes were invented, the central issue was the measurement of fine shapes on a surface on the nanometer (nm) order utilizing the high resolution. However, at the present time, the range of application of scanning probe microscopes has grown to include in-line automatic inspection for in-line inspection at a stage in the middle of systems for production of semiconductor devices. In actual inspection processes, measurement of extremely sharp relief at the fine relief shapes on the surfaces of the semiconductor devices formed on the substrates or wafers has become necessary.

In the past, as art for measuring such relief surfaces, there has been the scanning probe microscope described in Patent Document 1. The measurement system of this scanning probe microscope is the step-in system comprised of the step of feeding a probe and sample in a noncontact state by certain distances (a certain feed pitch), a step of bringing the probe into contact with the surface of the sample, and a step of measuring the contact position. By repeating these steps, the necessary region of the surface of the sample is measured by the raster scan system.

Further, as another prior art, there is the scanning probe microscope described in the following Patent Document 2. According to this scanning probe microscope, the probe is moved to scan the surface of the sample to be measured while following along the relief shapes. The measurement points (sampling points) are set so as to divide the distance followed along by the probe in the sample shape direction into equal distances. Therefore, the distances between measurement points along the sample surface become equal distances.

Patent Document 1: Japanese Patent Publication (A) No. 2-5340

Patent Document 2: Japanese Patent Publication (A) No. 2002-14025

### DISCLOSURE OF THE INVENTION

### Problem to be Solved by the Invention

The step-in type scanning probe microscope disclosed in Patent Document 1 presets a certain feed pitch enabling sufficient measurement of the shape of the surface of the sample and performed measurement based on this feed pitch, so performed measurement by the same fixed feed pitch when the surface had little change of shape in the step difference direction or when it had a large change, so more than the necessary time was taken. Further, when there were foreign matters or other unforeseen shapes, these were liable to end up being overlooked. From this viewpoint, the problem of the present invention is to shorten the measurement time in measurement of the surface of a sample by a scanning probe microscope, set the optimal feed pitch in accordance with the change of the sample surface in the step difference direction, and enable high precision measurement in accordance with a step difference of the sample surface.

The contact type scanning probe microscope disclosed in Patent Document 2 feeds the probe by a fixed feed pitch on the path of movement along the relief shapes of the sample surface and performs sampling for measurement at the measurement points. This conducted the measurement of the relief shapes of the sample surface by the same feed pitch when the change in shape in the step difference direction is small or large, so the overall time required for measurement becomes long. Conversely, there was the problem that when there were foreign matters or other unforeseen shapes, these were liable to end up being overlooked. From this viewpoint, the problem of the present invention is to shorten the measurement time in measurement of the surface of a sample by a scanning probe microscope and enable accurate measurement of parts of the sample surface where a large change occurs in the step difference direction.

An object of the present invention, in view of the above problems, is to provide a method of control of a probe scan of a scanning probe microscope and an apparatus for control of a probe scan in a scanning probe microscope measuring relief or uneven shapes of the sample surface by the step-in system which can shorten the measurement time, can accurately measure large step difference parts on a sample surface, and can perform measurement with a high precision by measurement by the optimum feed pitch in accordance with the step difference parts.

### Means for Solving the Problems

The method of control of a probe scan of a scanning probe microscope and apparatus for control of a probe scan according to the present invention are configured as follows to achieve the above object.

The method of control of a probe scan of a scanning probe microscope according to the present invention is a method of control in a scanning probe microscope which is provided with a probe unit having a probe facing a sample, a measurement unit detecting a physical quantity occurring between the probe and sample when the probe scans the surface of the sample and measuring surface information of the sample, and movement mechanisms changing the positional relationship between the probe and sample and performing a scanning operation and which uses the movement mechanisms to scan the surface of the sample by the probe and uses the measurement unit to measure the surface of the sample, comprising a step of using the movement mechanisms to feed the probe by a certain distance in a direction along the surface of the sample at a position separate from the surface, a step of using the movement mechanisms to make the probe approach the sample for measurement to obtain a measurement value at each of a plurality of measurement points determined by the certain distance then use the movement mechanisms to retract this, a step of setting a new measurement point at a position between a first measurement point and second measurement point when the difference between a measurement value at the first measurement point and a measurement value of the adjoining second measurement point is larger than a reference value, and a step of moving the probe by the movement mechanisms to the new measurement point for measurement.

The method of control of a probe scan of a scanning probe microscope according to the present invention is also a method of control in a scanning probe microscope which is provided with a probe unit having a probe facing a sample, a measurement unit detecting a physical quantity occurring between the probe and sample when the probe scans the surface of the sample and measuring surface information of the sample, and movement mechanisms changing the positional relationship between the probe and sample and performing a scanning operation and which uses the movement mechanisms to scan the surface of the sample by the probe and uses the measurement unit to measure the surface of the sample, comprising a step of feeding the probe by a certain distance in a direction along the surface of the sample at a position separate from the surface, a step of making the probe approach the sample for measurement to obtain a measurement value at each of a plurality of measurement points determined by the certain distance then retract this, and a step of setting a new measurement point for measurement at a position between a certain measurement point and next measurement point when the difference between a measurement value at the certain measurement point and a measurement value of the next measurement point is larger than a reference value.

The method of control of a probe scan of a scanning probe microscope according to the present invention performs measurement by step-in processing. In measurement by step-in processing, a predetermined number of measurement points are set at certain equal distances (equal measurement pitch). The probe moves between measurement points at a position away from the sample surface. When reaching the approach start point (position above the measurement point), it approaches and contacts the sample surface, executes the measurement, and retracts. When the step differences occurring at the sample surface are smaller than a reference value, it successively performs measurement at the measurement points at the predetermined certain distances. At locations with step differences larger than the reference value, it returns the probe in position, sets new measurement points, and performs measurement by a smaller measurement pitch. Due to this, it becomes possible to shorten the measurement time and perform high precision measurement at locations with large step differences.

Preferably, the method of control of a probe scan of a scanning probe microscope according to the present invention provides the above method of control of a probe scan wherein the position between the certain measurement point and next measurement point is a position determined by the intermediate value of a certain interval. In this configuration, by obtaining the measurement value at a intermediate point position, the method of control of the position becomes simplified and the change in height position data can be accurately grasped.

Preferably, the method of control of a probe scan of a scanning probe microscope according to the present invention provides the above method of control of a probe scan suspending the setting of a new measurement point when repeating measurement using positions between a certain measurement point and next measurement point as new measurement points and the minimum width between measurement points becomes smaller than a predetermined value. Due to this configuration, it is possible to give a reference for suspending repetition of interpolation measurement and thereby prevent the minimum width from exceeding the spatial resolution of the apparatus enabling shortening of the overall measurement time.

Preferably, the method of control of a probe scan of a scanning probe microscope according to the present invention provides the above method of control of a probe scan suspending the setting of a new measurement point when repeating measurement using positions between a certain measurement point and next measurement point as new measurement points and the number of times of setting a new measurement point becomes larger than a predetermined value. Due to this configuration, it is possible to give another reference for suspending repetition of interpolation measurement and thereby enable shortening of the overall measurement time.

The apparatus for control of a probe scan of scanning probe microscope according to the present invention is used for a scanning probe microscope which is provided with a probe unit having a probe facing a sample, a measurement unit measuring a physical quantity occurring between the probe and sample when the probe scans the surface of the sample, and movement mechanisms changing the positional relationship between the probe and sample and performing a scanning operation and which uses the movement mechanisms to scan the surface of the sample by the probe and uses the measurement unit to measure the surface of the sample. Further, the apparatus for control of a probe scan is provided with a probe feeding means for feeding the probe by a certain measurement pitch in a direction along the surface of the sample at a position separate from the surface, a measurement executing means for making the probe approach the sample for measurement to obtain a measurement value at each of a plurality of measurement points determined by the measurement pitch then retract this, and a measurement pitch varying means for varying the measurement pitch between a certain measurement point and next measurement point to set a measurement point when the difference between a measurement value at the certain measurement point and a measurement value of the next measurement point is larger than a reference value.

The above apparatus for control of a probe scan of scanning probe microscope performs measurement by step-in processing. In this measurement, a predetermined number of measurement points are set at certain equal distances (equal measurement pitch). In this apparatus for control of a probe scan, in the measurement by step-in processing, when the step differences occurring at the sample surface are smaller than a reference value, it successively performs measurement at the measurement points at the predetermined certain distances. At locations with step differences larger than the reference value, it returns the probe in position, sets new measurement points, and performs measurement by a smaller measurement pitch. Due to this, it becomes possible to shorten the measurement time and perform high precision measurement at locations with large step differences.

The method of control of a probe scan of a scanning probe microscope according to the present invention may also be used for a scanning probe microscope which is provided with a probe unit having a probe facing a sample, a detection unit detecting a physical quantity acting between the probe and sample, a measurement unit measuring surface information of the sample based on a physical quantity detected by the detection unit when the probe scans the surface of the sample, a probe movement use movement mechanism having at least two degrees of freedom, and a sample movement use movement mechanism having at least two degrees of freedom and which uses the probe movement use movement mechanism or the sample movement use movement mechanism to change the relative positional relationship between the probe and sample to make the probe scan the surface of the sample and uses the measurement unit to measure the surface of the sample. The above method of control of a probe scan performs measurement by a scan operation comprised of a step of using the sample movement use movement mechanism to feed the probe by a certain distance in a noncontact state with the sample, a step of making the probe approach the sample, and a step of making the probe retract from the sample and operates the probe movement use movement mechanism when a certain contact position has a predetermined step difference value larger than the previous contact position and obtains a position between a certain contact position and previous contact position for measurement in the scanning operation by this probe movement use movement mechanism.

In the above method of control of a probe scan, when using the scanning probe microscope for measurement by the step-in mode of a measurement region on the sample surface by scanning movement of the probe, either the sample movement use movement mechanism (coarse movement mechanism) or the probe movement use movement mechanism (fine movement mechanism) is used to change the relative position between the sample and probe. When the measurement region is a fine region, the probe movement use movement mechanism is used for a scan similar to the above-mentioned method. When the measurement region is a wide area, scan movement by the sample movement use movement mechanism is used for wide area measurement. When the step differences at the sample surface are larger than the reference value, the change in height of the relief (uneven or rough shape) on the sample surface is sharp, so the probe scanning operation is switched to the probe movement use movement mechanism, the probe is returned and the probe movement use movement mechanism is used to perform the scanning operation, and the step difference parts of the sample surface are measured by a more precise scanning operation. Due to this, it becomes possible to quickly and accurately measure the relief shapes of the sample surface by measurement of the sample surface by a scanning probe microscope. Note that in measurement by the step-in mode, a predetermined number of measurement points are set at certain equal distances (equal measurement pitch). The probe moves between measurement points at a position away from the sample surface. When reaching the approach start point (position above the measurement point), it approaches and contacts the sample surface, executes the measurement, and retracts.

Preferably, the method of control of a probe scan of a scanning probe microscope according to the present invention provides the above method of control of a probe scan wherein when the position between a certain contact position and previous contact position is first an intermediate position of said certain distance at the feed operation and the step differences between this intermediate position and the two ends are larger than a predetermined step difference value, the intermediate position is further obtained at the larger step difference side repeatedly until the step difference between the intermediate position and the two sides becomes smaller than a predetermined step difference value.

Preferably, the method of control of a probe scan of a scanning probe microscope according to the present invention provides the above method of control of a probe scan which suspends the acquisition of the intermediate position when obtaining an intermediate position as the measurement point and the minimum width between measurement points is smaller than a predetermined value.

Preferably, the method of control of a probe scan of a scanning probe microscope according to the present invention provides the above method of control of a probe scan which suspends the acquisition of the intermediate position when the number of times of obtaining the acquisition of the intermediate position becomes larger than a predetermined value.

Preferably, the method of control of a probe scan of a scanning probe microscope according to the present invention provides the above method of control of a probe scan which continues the feed operation of the sample movement use movement mechanism and operates the probe movement use movement mechanism.

Preferably, the method of control of a probe scan of a scanning probe microscope according to the present invention provides the above method of control of a probe scan which suspends the feed operation of the sample movement use movement mechanism and operates the probe movement use movement mechanism.

### EFFECTS OF THE INVENTION

According to the present invention, the next meritorious effects (1) to (5) are exhibited:

(1) In a scanning probe microscope performing step-in type measurement, the scan movement of the probe is controlled by switching to a coarse movement mechanism or fine movement mechanism in accordance with the severity of the step differences of the relief of the sample surface, so it is possible to find data showing the sample shape by the necessary precision and with less data. Further, it is also possible to perform measurement with a greater precision by using the fine movement mechanism for a feed operation or return operation at locations where the step differences of the sample surface are severe, so it is possible to obtain high precision measurement value data.

(2) Relief shapes of sample surfaces can be expressed by small amounts of data, so the time required for shape measurement can be shortened.

(3) It is possible to automatically add measurement points for measurement for step differences which cannot be sensed or predicted by measurement by the conventional ordinary step-in system.

(4) The number of measurement points can be reduced, so the probe life can be extended and the running cost can be reduced.

(5) The overall measurement time becomes shorter, so the effects of temperature drift etc. can be eliminated and the measurement precision can be improved.

### BEST MODE FOR CARRYING OUT THE INVENTION

Hereinafter, preferable embodiments of the present invention will be explained with reference to the drawings.

Based on FIG. 1, the overall configuration of a scanning probe microscope (SPM) according to the present invention will be explained. This scanning probe microscope is envisioned as an atomic force microscope (AFM) as a typical example.

At the bottom part of the scanning probe microscope, a sample stage 11 is provided. The sample stage 11 has a sample 12 on its top surface. The sample stage 11 is a mechanism for changing the position of the sample 12 by a three-dimensional coordinate system comprised of an orthogonal X-axis, Y-axis, and Z-axis. The sample stage 11 is comprised of an XY stage 14, Z-stage 15, and a sample holder 16. The sample stage 11 is usually configured as a coarse movement mechanism unit for causing displacement (position change) at the sample side. The top surface of a sample holder 16 of the sample stage 11 holds the above sample 12 of a relatively large area and sheet or flat thin-plate shape. The sample 12 is for example a substrate or wafer on whose surface integrated circuit patterns of semiconductor devices are fabricated. The sample 12 is fastened on the sample holder 16. The sample holder 16 is provided with a sample fastening chuck mechanism.

In the sample stage 11, specifically the XY stage 14 is a mechanism for moving the sample on the horizontal plane (XY plane), while the Z-stage 15 is a mechanism for moving the sample 12 in the vertical direction. The Z-stage 15 is provided at the XY stage 14.

In FIG. 1, at a position above the sample 12 is arranged an optical microscope 18 provided with a drive mechanism 17. The optical microscope 18 is supported by a drive mechanism 17. The drive mechanism 17 is comprised of a focus use Z-direction movement mechanism unit 17a for moving the optical microscope 18 in the Z-axial direction and an XY direction movement mechanism unit 17b for moving it in the XY axial directions. Due to the mounting, the Z-direction movement mechanism unit 17a moves the optical microscope 18 in the Z-axial direction, while the XY direction movement mechanism unit 17b moves the unit of the optical microscope 18 and the Z-direction movement mechanism unit 17a in the XY axial directions. The XY direction movement mechanism unit 17b is fastened to a frame member, but in FIG. 1 the illustration of the frame member is omitted. The optical microscope 18 is arranged with the object lens 18a facing downward and is arranged at a position approaching the surface of the sample 12 from directly above it. At the top end of the optical microscope 18, a TV camera (imaging device) 19 is attached. The TV camera 19 captures an image of a specific region of the sample surface caught by the object lens 18a and outputs the image data.

At the top side of the sample 12, a cantilever 21 provided with a probe 20 at its front end is arranged at a close proximity. The cantilever 21 is fastened to a mounting part 22. The mounting part 22 is, for example, provided with an air suction section (not shown). This air suction section is connected to an air suction device (not shown). The cantilever 21 is fastened and mounted by the large area base being held by suction operation of the air suction section of the mounting part 22.

The above mounting part 22 mounts a Z-fine movement mechanism 23 for causing a fine movement operation in the Z-direction. Further, the Z-fine movement mechanism 23 is attached to the bottom surface of the later explained support frame 25 at the cantilever displacement detection unit 24.

The cantilever displacement detection unit 24 is configured by the support frame 25 with a laser beam source 26 and a photo detector 27 attached to it in a predetermined positional relationship. The cantilever displacement detection unit 24 and the cantilever 21 are held in a certain positional relationship. A laser beam 18 emitted from the laser beam source 26 is reflected at the back surface of the cantilever 21 and strikes the photo detector 27. The above cantilever displacement detection unit forms an optical lever type photo detection device. This optical lever type photo detection device enables any displacement due to deformation such as twisting or bending occurring at the cantilever 21 to be detected.

The cantilever displacement detection unit 24 is attached to an XY fine movement mechanism 29. The XY fine movement mechanism 29 enables the cantilever 21 and probe 20 etc. to be moved by fine distances in the XY axial directions. At this time, the cantilever displacement detection unit 24 is simultaneously moved, so the positional relationship between the cantilever 21 and the cantilever displacement detection unit 24 remains unchanged.

In the above, the Z-fine movement mechanism 23 and the XY fine movement mechanism 29 are usually comprised of piezoelectric elements. The Z-fine movement mechanism 23 and the XY fine movement mechanism 29 enable movement of the probe 20 in the X-axial direction, Y-axial direction and Z-axial direction by fine distances (for example, several microns to 10 μm, a maximum 100 μm). The above XY fine movement mechanism 29 is attached to a not shown frame mechanism.

In the above mounting, the field of observation of the optical microscope 18 includes a specific region of the surface of the sample 12 and the front end part of the cantilever 21 including the probe 20 (back surface part).

Next, the control system of the scanning probe microscope will be explained. The control system is configured provided with a controller (first control apparatus) 33 and higher control apparatus (second control apparatus) 34. The controller 33 and higher control apparatus 34 are constructed by a computer system.

The controller 33 has provided inside it, as functional units, a comparison unit 31, control unit 32, first drive control unit 41, second drive control unit 42, image processing unit 43, data processing unit 44, XY scan control unit 45, X-drive control unit 46, Y-drive control unit 47, and Z-drive control unit 48. The controller 33 is a control apparatus for driving the different parts of the scanning probe microscope and is provided with the following functional units.

The above control unit 32 is a part having for example a Z-axial direction feedback control function forming a feedback loop and realizing in principle a measurement mechanism by an atomic force microscope (AFM).

The above comparison unit 31 compares a voltage signal Vd output from a photo detector 27 and a preset reference voltage (Vref) and outputs an error signal s1. The control unit 32 generates a control signal s2 so that the error signal s1 becomes 0 and gives this control signal s2 to a Z-fine movement mechanism 23. The Z-fine movement mechanism 23 receiving the control signal s2 adjusts the height position of the cantilever 21 and maintains the distance between the probe 20 and the surface of the sample 12 at a certain distance. The control loop from the above photo detector 27 to the Z-fine movement mechanism 23 is a loop for feedback servo control for detecting a state of deformation of the cantilever 21 by the optical lever type photo detection device when the probe 20 scans the sample surface and maintaining the distance between the probe 20 and sample 12 at a predetermined certain distance determined based on the reference voltage (Vref). Due to this control loop, the probe 20 is held a certain distance from the surface of the sample 12. If scanning the surface of the sample 12 in this state, it is possible to measure relief or uneven shapes of the sample surface.

The optical microscope 18 is changed in position by a drive mechanism 17 comprised of a focus use Z-direction movement mechanism unit 17a and an XY direction movement mechanism unit 17b. The first drive control unit 41 and the second drive control unit 42 of the controller 33 controls the operations of the Z-direction movement mechanism unit 17a and the XY direction movement mechanism unit 17b.

The image of the sample surface or cantilever 21 obtained by the optical microscope 18 is captured by the TV camera 19 and taken out as image data. The image data of the optical microscope 18 obtained by the TV camera 19 is input into the controller 33 and processed by the above image processing unit 43 provided at the inside.

In the feedback servo control loop including the control unit 32 etc., the control signal s2 output from the control unit 32 means the height signal of the probe 20 in the scanning probe microscope (atomic force microscope). The height signal of the probe 20, that is, the control signal s2, enables information relating to a change in the height position of the probe 20 to be obtained. The above control signal s2 including the height position information of the probe 20, as explained above, is given to the Z-fine movement mechanism 23 for drive control and is fetched into the data processing unit 44 in the controller 33.

The scan of the sample surface by the probe for the measurement region of the surface of the sample 12 is performed by driving the XY fine movement mechanism 29. The control of the drive operation of the XY fine movement mechanism 29 is performed by the XY scan control unit 45 providing the XY fine movement mechanism 29 with an XY scan signal s3. In this embodiment, as explained later, step-in type scan and measurement are performed.

Here, the “step-in system” is the system of measurement comprising moving the probe in the state separated from the surface of the sample by a certain distance, making it approach the sample surface at the location of a measurement point, bringing it into contact with it for measurement, then retracting it again to the position separated by a certain distance when moving the probe between a preset plurality of measurement points (sampling points).

Further, the drive operation of the XY stage 14 and Z-stage 15 of the coarse movement mechanism, that is, the sample stage 11, is controlled by the X-drive control unit 46 outputting an X-direction drive signal, Y-drive control unit 47 outputting a Y-direction drive signal, and Z-drive control unit 48 outputting a Z-direction drive signal.

Note that the controller 33 is provided with a storage unit (not shown) for storing and holding, in accordance with need, set control data, input optical microscope image data, and data relating to height position of the probe.

The higher control apparatus 34 stores and executes an ordinary measurement program, sets and stores ordinary measurement conditions, stores and executes an automatic measurement program, sets and stores measurement conditions, stores measurement data, processes the measurement results, stores them on a display device (monitor) 35, and performs other processing for the above controller 33. In setting the measurement conditions, basic items such as the measurement range and measurement speed and other conditions for automatic measurement are set. These conditions are stored and managed in a setting file. Further, it is also possible to configure the apparatus to have a communication function and to provide a function of communicating with an outside device.

Since the higher control apparatus 34 has the above functions, it is comprised of a processing apparatus constituted by a CPU 51 and a storage unit 52. The storage unit 52 stores and holds the above programs and condition data, etc. Further, the higher control apparatus 34 is provided with an image display control unit 53, a communication unit, etc. In addition, the second control apparatus 34 is connected through an interface 54 to an input device 36 and can set and change the measurement program, measurement conditions, data, etc. stored in the storage unit 52 through the input device 36.

The CPU 51 of the higher control apparatus 34 provides higher control instructions, etc. through a bus 55 to different functional parts of the controller 33. Further, the image processing unit 43, data processing unit 44, etc. provide image data and data relating to the height position of the probe.

Next, the basic operation of the above scanning probe microscope (atomic force microscope) will be explained.

The front end of the probe 20 of the cantilever 21 is made to approach a predetermined region of the surface of the semiconductor substrate or other sample 12 placed on the sample stage 11. Usually, the probe approach mechanism as constituted by the Z-stage 15 makes the probe 20 approach the surface of the sample 12 and causes the atomic force to act on it to cause the cantilever 21 to bend and deform. The amount of bending due to the bending and deformation of the cantilever 21 is detected by the above-mentioned optical lever type photo detection device. By moving the probe 20 with respect to the sample surface in this state, the sample surface is scanned (XY scanning). The probe 20 is made to scan the surface of the sample 12 by an XY scan by making the probe 20 side move by the XY fine movement mechanism 29 (fine movement) or by making the sample 12 side move by the XY stage 14 (coarse movement) so as to create relative movement between the sample 12 and the probe 20 in the relative XY plane.

The probe 20 side is moved by giving the XY fine movement mechanism 29 provided with the cantilever 21 with an XY scan signal s3 relating to XY fine movement. The scan signal s3 relating to the XY fine movement is given from the XY scan control unit 45 in the controller 33. On the other hand, the sample side is moved by giving drive signals to the XY stage 14 of the sample stage 11 from the X-drive control unit 46 and Y-drive control unit 47.

The above XY fine movement mechanism 29 is configured by a piezoelectric element and enables high precision and high resolution scan movement. Further, the range of measurement measured by the XY scan by the XY fine movement mechanism 29 is limited by the stroke of the piezoelectric element and even at the maximum is a range determined by a distance of about 100 μm. According to the XY scan by the XY fine movement mechanism 29, the measurement becomes a fine narrow range of measurement. On the other hand, the above XY stage 14 is usually configured utilizing an electromagnetic motor as the drive unit, so the stroke can be increased to several hundred mm. According to the XY scan by the XY stage, a wide range of measurement becomes possible.

In the above way, a predetermined measurement region on the surface of the sample 12 is scanned by the probe 20 by the step-in system and the amount of bending (amount of deformation due to bending) of the cantilever 21 is controlled to become fixed at all measurement points based on the feedback servo control loop. The amount of bending of the cantilever 21 is controlled so as to always match with the target amount of bending serving as the reference (set by reference voltage Vref). As a result, the distance between the probe 20 and the surface of the sample 12 is held at a certain distance. Therefore, the probe 20 can scan the fine relief shapes (profile) of the surface of the sample 12 by the step-in system and measure the fine relief shapes of the surface of the sample 12 by obtaining the height signal of the probe at the measurement points.

The principle of detection of displacement by an optical lever type optical detection apparatus will be explained in detail next with reference to FIG. 2. The above cantilever 21 displaces in one or both of the for example A1 direction and B1 direction based on the atomic force acting on the probe 20 at the front end. As a result, bending, twisting, or other deformation occurs in the cantilever 21. In the cantilever displacement detection unit 24, the laser beam 28 emitted from the laser beam source 26 is fired at the back surface of the cantilever 21, is reflected at the back surface, and enters the photo detector 27. In FIG. 2, a reference number 27a designates a light receiving surface. In the initial condition, the spot position where the reflected laser beam 28 strikes the light receiving surface 27a of the photo detector 27 in the state where no force is applied to the probe 20 is stored. After this, it is possible to precisely detect the magnitude and direction of the force applied to the probe 20 by capturing the direction of movement of the spot position on the light receiving surface 27a of the photo detector 27 caused by deformation of the cantilever 21. For example, in FIG. 2, when the probe 20 receives force in the A1 direction, it is possible to capture the change of the spot position in the A2 direction at the light receiving surface 27a of the photo detector 27. Further, when the probe 20 receives force in the B1 direction, it is possible to capture the change of the spot position in the B2 direction at the light receiving surface 27a of the photo detector 27. From here on, force in the A1 direction will be referred to as twisting direction force, while force in the B1 direction will be referred to as bending direction force.

Next, the method of control of the above probe scan according to a first aspect of the invention executed by a scanning probe microscope will be explained with reference to FIG. 3 to FIG. 5. In the explanation of this method of control of a probe scan, the scanning operation of the probe (cantilever) and the measurement operation by the probe at the measurement points (sampling points) will be explained.

FIG. 3 shows the state of measurement of the relief shapes on the surface of the sample 12 by the above-mentioned step-in system, FIG. 4 shows the step-in processing (a) and the movement operation (b) of the probe 20 at each measurement point, and FIG. 5 shows the control routine for realizing the probe scanning operation shown in FIG. 3 by a PAD expression.

In FIG. 3, the surface of the sample 12 is formed with a large step difference 12a. According to a scan type atomic force microscope, based on the step-in system, the probe 20 is made to scan the sample surface by preset certain distances (measurement pitch) to measure the surface. The plurality of positions (A), (B), (C), (D), (E), (F), and (G) shown in FIG. 3 show part of the large number of predetermined measurement points. The probe 20 moves scanning the X-direction and measures the measurement points (A) to (G). The probe 20 moves between measurement points at a predetermined height separated from the sample surface by a certain distance. At the measurement points (A) to (G), the probe 20 approaches and contacts the sample surface for measurement, then retracts from the sample surface. Note that as shown in FIG. 3, at the surface of the sample 12, there is the above step difference 12a a section between the measurement points (C) and (D), so according to the method of control of a probe scan of the present embodiment, at the section between the measurement points (C) and (D), the probe 20 reverses its direction of movement and returns, divides the section further finer, and performs step-in type measurement by shorter distances. In the illustrated example, the measurement points (D)-1, (D)-2, and (D)-3 are set.

FIG. 4(b) shows the state of operation where the probe 20 moved in the state separated from the sample surface by exactly a certain distance approaches and contacts the surface of the sample 12 for measurement at any measurement point (step-in operation (Pn→Dn)). Corresponding to this step-in operation, FIG. 4(a) shows the process of the “step-in processing (Pn→Dn)”. At the step-in operation (Pn Dn), the front end of the probe 20 engaged in the scan movement (upper approach start position Pn) approaches and contacts a predetermined measurement point on the surface of the sample 12 (surface position Dn) for measurement, then retracts. The “step-in processing (Pn→Dn)” is control processing for executing this “step-in operation (Pn→Dn)”. The movement shown by the arrow 61 is movement for the scan and is executed at step S11 of the approach start point movement processing. After this, the movement shown by the arrow 62 at the measurement point is movement for approach and is executed at step S12 of the probe approach processing. The front end of the probe 20 contacts the surface of the sample 12, then that contact state is stably held. Step S13 is a step for processing contact stability. In this contact state, processing for position measurement is performed (step S14). In the processing for position measurement, the height of the surface of the sample 12 (Z-axial direction position) is measured based on the principles of the AFM. When the position measurement ends, the probe 20 separates from the surface of the sample 12 (arrow 63) and retracts to a predetermined height position (step S15).

Next, the operation of the probe 20 shown in FIG. 3 will be explained with reference to the flow chart of FIG. 5.

In FIG. 5, “n” means a position counter, “step-in processing Pn→Dn” means the execution of the process shown in FIG. 4(a), “Pn:n=1, 2, 3, . . . ” means the series of points showing the upper position at the measurement point (approach start position), and “Dn:n=1, 2, 3, . . . ” is the series of points showing the surface positions of the measurement points. These show measurement values (numerical values). In the series of points Pn, the distance between the points are set to certain equal distances (equal measurement pitch).

The equation block 71 is sentence processing and means the entry of the numerical value “0” for the variable n (position counter). Further, the sentence blocks 72, 73, 74, and 75 are IF sentences. These mean branches where when the top side of the block is YES, the bottom side of the block is NO. Specifically, for example, the “Pn not yet measured” of the sentence block 72 is used for judging whether measurement has been performed at the measurement point of the position Pn. In the case of YES, the process of “step-in processing Pn→Dn” (FIG. 4(a)) is executed and the measurement value Dn is entered for the variable X1, while in the case of NO, similarly the measurement value Dn is entered for the variable X1. Further, the equation block 76 means repeated processing for repeating Pn until n becomes the final value.

The movement operation of the probe shown in FIG. 3 under the above rule in FIG. 5 will be explained. The height position data (measurement value) obtained by executing the step-in processing at the measurement point (A) and the height position data obtained by executing the step-in processing at the next measurement point (B) are compared for magnitude and the difference (step difference) is defined as δ1. This δ1 is smaller than the predetermined Δz (reference setting value), so the probe 20 moves to the next measurement point (C). At the measurement point (C), the height position data is obtained based on the above step-in processing. In the comparison of the measurement value of the measurement point (C) and the measurement value of the measurement point (B) as well, the difference is smaller than Δz, so the probe 20 moves to the next measurement point (D). At the measurement point (D) as well, the height position data is obtained based on the above step-in processing. In this case, in the comparison of the measurement value of the measurement point (D) and the measurement value of the measurement point (C), the difference 62 is larger than Δz, so the position of the probe 20 is returned to the intermediate point (D)-1 between the measurement point (C) and the measurement point (D).

The above operation will be viewed using the control routine of FIG. 5. First, the position counter n is cleared to 0 (step S21) to enable the start of measurement by step-in processing from the approach start point P0. The point P0 is not yet measured (step S22), so the step-in processing is performed (step S23) and the height position data (measurement value) Dn is obtained. Next, since the next point Pn+1 is not yet measured (step S24), similarly the step-in processing is performed (step S25) and the height position data (measurement value) Dn+1 is obtained. When comparing Dn and Dn+1 and the difference is smaller than Δz (step S26), the position counter n is advanced (step S27). When comparing Dn and Dn+1 and the difference is larger than Δz, the approach start position is complemented (step S31). The measurement from the measurement points (A) to (D) is based on measurement by step-in processing in the case where the difference between the measurement values of two adjoining points is smaller than Δz, comparison of the measurement values, and movement to the next measurement point, while the measurement from the measurement points (D) to (D)-1 is based on measurement by step-in processing in the case where the difference between the measurement values of two adjoining points is larger than Δz, comparison of the measurement values, and movement to the next measurement point.

Next, at the measurement point (D)-1 of the intermediate point between (C) and (D), the height position data is obtained by step-in processing. In this case as well, in the comparison of the measurement value of the measurement point (D)-1 and the measurement value of the measurement point (C), the difference 3 is larger than Δz, so the position of the probe 20 is returned to the intermediate point (D)-2 between the measurement point (C) and the measurement point (D)-1.

Next, at the measurement point (D)-2 of an intermediate point between (C) and (D)-1, height position data is obtained by step-in processing. In this case, in the comparison of the measurement value of the measurement point (D)-2 and the measurement value of the measurement point (C), the difference δ4 is smaller than Δz. Therefore, next, the step difference δ5 between the measurement points (D)-2 and (D)-1 is compared with Δz. δ5 is smaller than Δz, so the step difference δ6 of the next measurement points (D)-1 and (D) is compared with Δz. If the step difference δ6 is larger than Δz, the position of the probe 20 is moved to an intermediate position (D)-3 between the measurement points (D)-1 and (D).

At the intermediate position point (D)-3, height position data is obtained by step-in processing. In the comparison of the measurement value of the measurement point (D)-3 and the measurement value of the measurement point (D)-1, the difference δ7 is smaller than Δz, so next the measurement value of the measurement point (D)-3 and the measurement value of the measurement point (D) are compared to obtain the difference δ8. δ8 is smaller than Δz, so the probe 20 moves to the next measurement point (E) then continues the measurement. The above operation is repeated until the final measurement point.

As the intermediate points between the above measurement points (C) and (D), the measurement points (D)-1, (D)-2, and (D)-3 are newly set in accordance with the condition. The AFM measurement by step-in processing is interpolation measurement for measuring any large step difference occurring at the sample surface by a higher precision. If the difference in measurement values at two adjoining positions is larger than Δz, interpolation measurement is performed (step S31). This interpolation measurement is performed in accordance with the YES condition at step S28. In the calculation of the interpolation position of the interpolation measurement, the intermediate position is made the interpolated position, but the invention is not limited to this. In the above interpolation measurement, the measurement pitch for interpolation (interpolation pitch) becomes smaller. However, the reference distance Δx is set so that this interpolation pitch does not become too small (step S28). When larger than the interpolation pitch, the approach start point and measurement point data are shifted one by one (steps S29, S30) and the intermediate position is registered as the approach start position (step S31). Further, when the interpolation pitch becomes smaller than Δx, no interpolation is performed (step S32).

FIG. 6 is a view of functional blocks of the scanning probe microscope (atomic force microscope) according the present embodiment described above. This scanning probe microscope is provided with a probe unit 71 having a probe 20 facing a sample 12, a measurement unit 73 measuring a physical quantity (72) occurring between the probe 20 and the sample 12 when the probe 20 scans the surface of the sample 12, and a movement mechanism 74 changing the positional relationship between the probe 20 and sample 12 and performing a scanning operation (sample stage 11, Z-fine movement mechanism 23, and XY fine movement mechanism 29) and uses the movement mechanism 74 to make the probe 20 scan the surface of the sample 12 and use the measurement unit 73 to measure the surface of the sample 12. This scanning probe microscope is further provided with a probe feeding means 75 for feeding the probe 20 by a certain measurement pitch in a direction along the surface of the sample 12 at a position separate from said surface, a measurement executing means 76 for making the probe approach the sample for measurement to obtain a measurement value at each of a plurality of measurement points determined by the measurement pitch then retract this, and a measurement pitch varying means 77 for varying the measurement pitch between a certain measurement point and next measurement point to set a measurement point when the difference between a measurement value at said certain measurement point and a measurement value of said next measurement point is larger than a reference value.

Next, the method of control of a probe scan according to the second aspect of the present invention worked by the above scanning probe microscope will be explained with reference to FIG. 7 to FIG. 11. In the explanation of this method of control of a probe scan as well, the scanning operation of the probe (cantilever) and the measurement operation of the probe at each measurement point (sampling point) will be explained.

FIG. 7 shows the state of measurement by the step-in system of relief shapes of the relatively wide area surface of the sample 12 by the above-mentioned coarse movement mechanism (sample stage 11) and fine movement mechanism (Z-fine movement mechanism 23 and XY fine movement mechanism 29), FIG. 8 is a view showing the step-in processing (a) at each measurement point and the movement operation (b) of the probe 20 by the coarse movement mechanism (sample stage 11), FIG. 9 is a view showing the step-in processing (a) at each measurement point and the movement operation (b) of the probe 20 by the fine movement mechanism (Z-fine movement mechanism 23 and XY fine movement mechanism 29), FIG. 10 is a view showing the control routine for realizing the probe scanning operation shown in FIG. 7 and FIG. 8 by a PAD expression, and FIG. 11 is a view showing the control routine for realizing the probe scanning operation shown in FIG. 7 and FIG. 9 (fine movement stage interpolation processing) by a pad expression.

In FIG. 7, a large step difference 12a is formed at the relatively wide area surface region at the surface of the sample 12. Since it is a wide area surface region, that surface region is shown divided into three parts by cut parts 101, 102. According to a scanning type atomic force microscope, first the XY stage 14 of the sample stage 11 is used by the step-in system to make the probe 20 scan and measure the sample surface in a preset feed direction (X-direction) by a certain distance (measurement pitch). The plurality of positions (A), (B), (C), (D), (E), (F), and (G) shown in FIG. 7 show part of the large number of predetermined measurement points. These measurement points (A) to (G) are measurement points planned in advance by the measurer. The measurement operation of the probe 20 at the measurement points (A) to (G) is shown in FIG. 8. At the measurement points (A) to (G), in FIG. 7, for example, as shown in (A), (D), and (G), there are scanning sections 103, 104, and 105 by the fine movement stage finer than the operation range of the coarse movement mechanism. At these scanning sections 103 to 105, the fine movement mechanism (fine movement stage) is used to make the probe 20 move finely and make the probe 20 perform the measurement operation. Note that section 104 shows the current scanning range, section 103 shows the past scanning range, and section 105 shows the future scanning range.

In FIG. 7, for example, (D)-1, (D)-2, and (D)-3 indicated by (D) plus a hyphen in the section corresponding to the measurement point (D) show the measurement points at the section 104 moved to by the fine movement mechanism. Note that the measurement by the fine movement mechanism at the measurement points (A) to (G) is executed only when the specific condition is met that shape information of fine parts has to be obtained.

The probe 20 is made one which scans the X-direction by coarse movement by the XY stage 14 of the sample stage 11 and measure the measurement points (A) to (G). Between the measurement points, the probe 20 moves at a predetermined height separated from the sample surface by exactly a certain distance. At the measurement points (A) to (G), the probe 20 approaches and contacts the sample surface by the Z-fine movement mechanism 23 for measurement, then retracts from the sample surface.

FIG. 8(b) shows the operation state (step-in operation (Pn Dn)) where, for example, at the measurement point (D) (surface position Dn) among the measurement points (A) to (G), the XY stage 14 (referred overall as the “coarse movement stage”) is used to move the probe in the X- or Y-direction, then the Z-fine movement mechanism 23 is used to make the probe 20 approach and contact the surface of the sample 12 for measurement, then retract it.

At the above time, only the XY stage 14 and Z-fine movement mechanism 23 operate. The Z-stage 15 and the XY fine movement mechanism 29 stop. The XY fine movement mechanism 29 side is, for example, fastened near the end of the stroke in the relative feed direction of the probe 20 and fine movement mechanism. This becomes movement in the state where the probe 20 does not contact the surface of the sample 12.

Corresponding to the above step-in operation, FIG. 8(a) shows the process of “step-in processing (Pn→Dn)”. In the step-in operation (Pn→Dn), the front end of the probe 20 in the scan motion (upper approach start position Pn) approaches and contacts the measurement point D (surface position Dn) of the surface of the sample 12 for measurement, then retracts. The “step-in processing (Pn→Dn)” is control processing for executing the “step-in operation (Pn→Dn)”. The motion shown by the arrow 161 is coarse movement for scanning and is executed by step S51 of the approach start point movement processing. After this, the movement shown by the arrow 162 at the measurement point (D) is movement for approach and is executed at step S52 for probe approach. The front end of the probe 20 contacts the surface of the sample 12 (surface position Dn), then that contact state is stably held. Step S53 is a step for processing contact stability. In this contact state, the processing for position measurement is performed (step S54). In the processing for position measurement, the height (Z-axial direction position) of the surface of the sample 12 is measured based on the principle of AFM. After the position measurement ends, next the probe 20 separates from the surface of the sample 12 (arrow 163) and retracts to a predetermined height position (step S55).

After the measurement of measurement point (D) ends, the probe moves to the next measurement point (E) where the above measurement operation is repeated. The above measurement operation performs a feed operation by the coarse movement stage, so is called the “coarse movement stage step-in processing”.

As shown in FIG. 7, at the surface of the sample 12, the above step difference 12a occurs at the section between the measurement points (C), (D), so according to the method of control of a probe scan of the present embodiment, at the section between the measurement points (C) and (D), the probe 20 reverses its direction of movement and returns, divides the section further finer, and performs step-in type measurement by shorter distances at the measurement points (D)-1, (D)-2, (D)-3.

Step-in type measurement based on the fine movement mechanism will be explained in accordance with FIG. 9. FIG. 9(b) shows, for example, the state of operation where the probe 20 moved in the state separated from the sample surface by exactly a certain distance approaches and contacts the surface of the sample 12 for measurement at for example the measurement point (D)-1 (surface position Dn) by the Z-fine movement mechanism 23 and XY fine movement mechanism 29 (referred to overall as the “fine movement stage”).

At the above time, the fine movement stage operates. Since the operating speed of the XY fine movement mechanism 29 is sufficiently faster than the XY stage 14, the XY stage 14 may be made to continue the feed operation or may be made to stop.

Corresponding to the above step-in operation, FIG. 9(a) shows the process of “step-in processing (Pn→Dn)”. In the step-in operation (Pn→Dn), the front end of the probe 20 in the scan motion (upper approach start position Pn) approaches and contacts the measurement point (D)-1 of the surface of the sample 12 (surface position Dn) for measurement, then retracts. The “step-in processing (Pn→Dn)” is control processing for executing this “step-in operation (Pn→Dn)”. The movement shown by the arrow 261 is fine movement for scanning and is executed by step S111 of the approach start point movement processing. After this, the movement shown by the arrow 262 at the measurement point (D)-1 is movement for approach and is executed by step S112 of the probe approach processing. The front end of the probe 20 contacts the surface of the sample 12 (surface position Dn), then that contact state is stably held. Step S113 is the step of processing the contact stability. In this contact state, processing for position measurement is performed (step S114). In the processing for position measurement, based on the AFM principle, the height of the surface of the sample 12 (Z-axial direction position) is measured. When the position measurement ends, next the probe 20 separates from the surface of the sample 12 (arrow 263) and retracts to a predetermined height position (step S115).

After measurement of the measurement point (D)-1 ends, the probe moves to the next measurement point based on the later explained predetermined condition and the above measurement operation is repeated. The above measurement operation involves a feed operation by the fine movement stage, so will be called “fine movement stage step-in processing”.

Returning again to FIG. 7, the series of operations of the probe 20 will be explained.

At the measurement point (A), coarse movement stage step-in processing is performed, the obtained position data and the position data obtained in the same way at the next measurement point (B) are compared, and the step difference between them is designated at δ1. Assume this step difference δ1 is smaller than the predetermined reference value Δz. When this condition is satisfied, the probe 20 moves to the next measurement point (C). At the measurement point (C) as well, coarse movement stage step-in processing is performed and the position data is obtained. If comparing the position data of the measurement point (C) and the position data of the measurement point (B), since the step difference is smaller than the set reference value Δz, the probe 20 moves to the next measurement point (D). When the step difference between a certain measurement point and a previous (or later) measurement point is smaller than Δz, the coarse movement stage step-in processing is repeated.

The step difference δ2 between the position data obtained by the measurement at the next measurement point (D) and the measurement data of the previous measurement point (C) becomes larger than the above Δz. For this reason, after this, the measurement system is switched from the coarse movement stage step-in processing system to the fine movement stage step processing system. Further, the feed operation of the fine movement stage returns the probe 20 to the intermediate position (D)-1 between the measurement points (C) and (D). At the intermediate position (D)-1, fine movement stage step-in processing is performed for measurement to obtain position data. The step difference δ3 between the position data of the measurement point (C) and the position data of the intermediate position (D)-1 is also larger than Δz, so the probe 20 is returned to the intermediate position (D)-2 between (C) and (D)-1. The step difference δ4 obtained by measurement by fine movement stage step-in processing at the position (D)-2 is also smaller than Δz, so the step difference δ5 between the position (D)-2 and the position (D)-1 is compared with Δz. Since this step difference 65 is smaller than Δz, next the step difference δ6 between the position (D)-1 and the above measurement point (D) is found and compared with Δz. The step difference 86 is larger than the predetermined Δz, so the probe 20 is moved to the intermediate position (D)-3 between the position (D)-1 and the measurement point (D) to perform measurement by the fine movement stage step-in processing and similarly obtain the step difference 67. The step difference 67 is smaller than the predetermined above Δz, so the step difference 68 between the position (D)-3 and measurement point (D) is found and compared with Δz. The step difference 68 is also smaller than Δz, so the fine movement stage step-in processing system is ended, the coarse movement stage step-in processing system is shifted to, and the probe 20 is made to move to the next measurement point (E).

Next, the above series of operations of the probe 20 will be explained referring to the flow charts of FIG. 10 and FIG. 11 and referring to the operation of the probe 20 shown in FIG. 7 to FIG. 9. FIG. 10 shows the flow of the overall operation based on the coarse movement stage step-in processing, while FIG. 11 shows the flow in the case of shifting to fine movement stage step-in processing.

In FIG. 10, ‘n’ means a position counter, “coarse movement stage step-in processing Pn→Dn” means execution of the process by coarse movement stage step-in processing shown by FIG. 8(a), “Pn:n=1, 2, 3, . . . ” means the series of points showing the upper position at the measurement point (approach start position), and “Dn:n=1, 2, 3, . . . ” is the series of points showing the surface positions of the measurement points. These show measurement values (numerical values). In the series of points Pn, the distance between the points are set to certain equal distances (equal measurement pitch).

The equation block 91 is sentence processing and means the entry of the numerical value “0” for the variable n (position counter). Further, the sentence blocks 92, 93, and 94 are IF sentences. These mean branches where when the top side of the block is YES, the bottom side of the block is NO. Specifically, for example, the “Pn not yet measured” of the sentence block 92 is used for judging whether measurement has been performed at the measurement point of the position Pn. In the case of YES, the process of “coarse movement stage step-in processing Pn→Dn” (FIG. 8(a)) is executed and the measurement value Dn is entered for the variable X1, while in the case of NO, similarly the measurement value Dn is entered for the variable X1. Further, the equation block 95 means repeated processing for repeating Pn until n becomes the final value.

The movement operation of the probe shown in FIG. 7 under the above rule in FIG. 10 will be explained. The height position data (measurement value) obtained by executing the coarse movement stage step-in processing at the measurement point (A) and the height position data obtained by executing the step-in processing at the next measurement point (B) are compared for magnitude and the difference (step difference) is defined as δ1. This δ1 is smaller than the predetermined above Δz (reference setting value), so further, next, the probe 20 is moved to the measurement point (C). At the measurement point (C), the height position data is obtained based on the above coarse movement stage step-in processing. In the comparison of the measurement value of the measurement point (C) and the measurement value of the measurement point (B) as well, the difference is smaller than Δz, so the probe 20 is moved to the next measurement point (D). At the measurement point (D) as well, the height position data is obtained based on the above step-in processing. In this case, in the comparison of the measurement value of the measurement point (D) and the measurement value of the measurement point (C), the difference 62 is larger than Δz, so the position of the probe 20 as mentioned above is returned to an intermediate point (D)-1 between the measurement point (C) and the measurement point (D).

The above operation will be viewed by the control routine of FIG. 10. First, the position counter n is cleared to 0 (step S61) to enable the start of measurement from the approach start point P0 based on the coarse movement stage step-in processing. The point P0 is not yet measured (step S62), so coarse movement stage step-in processing is performed (step S63) to obtain the height position data (measurement value) Dn. At the next point Pn+1, similarly coarse movement stage step-in processing is performed (step S64) to obtain the height position data (measurement value) Dn+1. When comparing Dn and Dn+1 and the difference is smaller than Δz (step S65), the position counter n is incremented (step S66). When comparing Dn and Dn+1 and the difference is larger than Δz, it is judged whether it is possible to shift from the coarse movement stage step-in processing to fine movement stage step-in processing.

For this reason, first, the approach start position is interpolated. As explained above, in this embodiment, the interpolation calculation interpolates the intermediate position of the section between the measurement points (C) and (D). It is judged that the interpolation pitch has not become too small if the interpolated position is in the range of movement by the fine movement stage (step S67). The Δx at step S67 means the lower limit value of the interpolation pitch. When the result of judgment is YES, the approach start point and the measurement point data are shifted one each (steps S68, S69), the intermediate position is registered as the approach start position (step S81), and measurement by fine movement stage step-in processing, that is, “fine movement stage interpolation processing (step S82)”, is performed. Further, when the result of judgment is NO, the counter n is advanced and no interpolation is performed (step S83). The above operation is repeated until the final point.

In the above, in the measurements by this embodiment, the measurement from the measurement point (A) to (D) is based on measurement by coarse movement stage step-in processing in the case where the difference between the measurement values of two adjoining points is smaller than Δz, comparison of the measurement values, and movement to the next measurement point, while the measurement from the measurement points (D) to intermediate position (D)-1 is based on measurement by fine movement stage step-in processing in the case where the difference between the measurement values of two adjoining points is larger than Δz, comparison of the measurement values, and movement to the next measurement point.

Next, fine movement stage interpolation processing (step S82) will be explained with reference to FIG. 11. In this fine movement stage interpolation processing, the measurement between the point Pn (measurement point (C)) and point Pn+1 (point (D)-1) and point Pn+2 (measurement point (D)) is performed by a certain pattern. When the measurement point moves to the next measurement point by the coarse movement stage step-in processing, the fine movement stage interpolation processing is ended.

At step S141 of FIG. 11, the point Pn+1 interpolated at FIG. 10 is not yet measured, so the measurement value Dn+1 is obtained by the fine movement stage step-in processing (steps S142 and S143). If the difference between Dn and Dn+1 is smaller than Δz (step S144), the counter n is advanced (step S145, S146). If here, the difference between Dn and Dn+1 is larger than Δz, further the approach start position is interpolated (steps S145, S146, S147 and S148). In this example, the interpolation calculation interpolates the position halfway in the section covered (intermediate position). Further, at this step as well, it is judged that the interpolation pitch has not become too small if in the range of movement by the fine movement stage (step S145). Ax is the lower limit value of the interpolation pitch. When the result of judgment is NO, the counter n is advanced and interpolation is not performed (steps S149, S150). When the result of judgment is YES, the approach start position and the measurement point data are shifted by one, the intermediate position is registered in the approach start position, and fine movement stage interpolation processing is performed (steps S146, S147, S148). The above operation is repeated.

With measurement by fine movement stage step-in processing, when the minimum width between measurement points becomes smaller than a predetermined value when using an intermediate position as the measurement point, use of the intermediate position is suspended. Further, according to the above method of control of a probe scan, when the number of times of use of intermediate positions becomes larger than a predetermined value, use of an intermediate value can also be suspended.

The configurations, shapes, sizes, and relative arrangements explained in the above embodiments are only generally shown to an extent enabling the present invention to be understood and worked. Further, the numerical values and compositions (materials) of the configurations are only illustrations. Therefore, the present invention is not limited to the embodiments explained above and can be modified in various ways so long as not departing from the scope of the technical idea shown in the claims.

### INDUSTRIAL APPLICABILITY

The present invention enables a sample surface with a step difference to be measured in a short time by step-in type measurement by a scanning probe microscope and simultaneously enables detailed measurement data to be obtained while changing the measurement pitch at the step difference parts. Further, it enables detailed measurement data to be obtained at step difference parts by switching from the coarse movement stage to the fine movement stage and changing the measurement pitch.

### BRIEF DESCRIPTION OF THE DRAWINGS

FIG. 1 A view of the configuration showing the overall hardware configuration of a measurement unit and control unit of a scanning probe microscope according to the present invention.

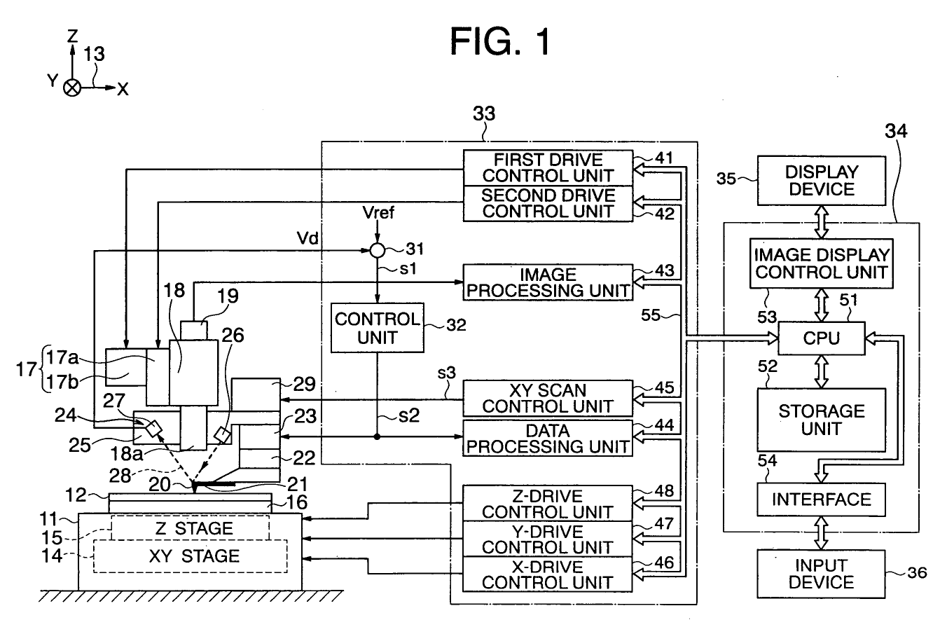

FIG. 2 An explanatory view showing the relationship between a cantilever and probe and an optical lever type photo detection device in a scanning probe microscope.

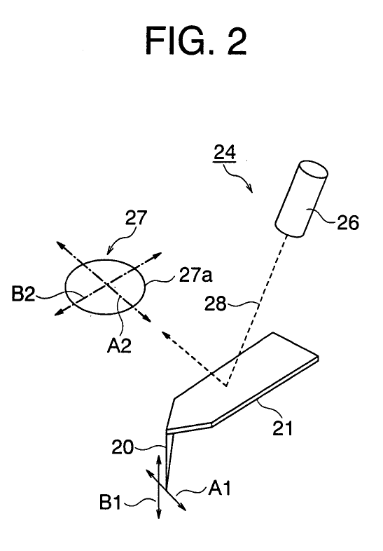

FIG. 3 A view showing a scanning and measurement operation of a probe by a step-in system in a scanning probe microscope according to the present invention.

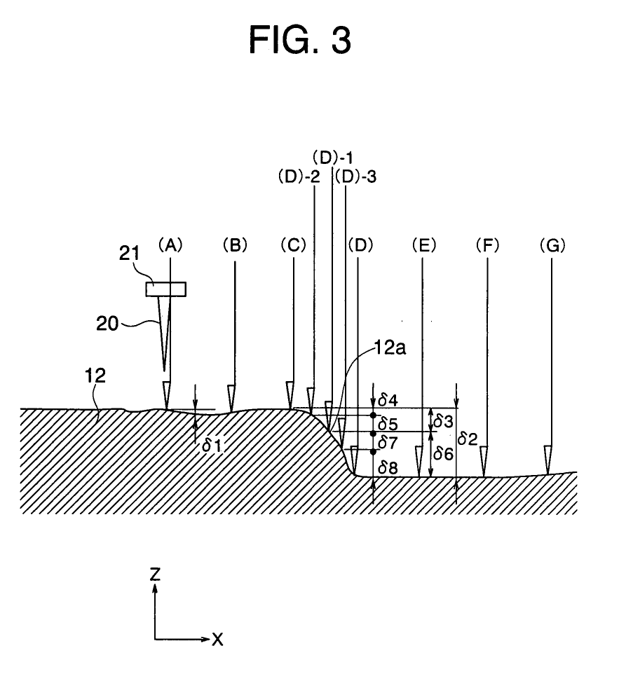

FIG. 4 A view explaining a measurement operation (sampling operation) by a step-in system of a step-in type scanning probe microscope.

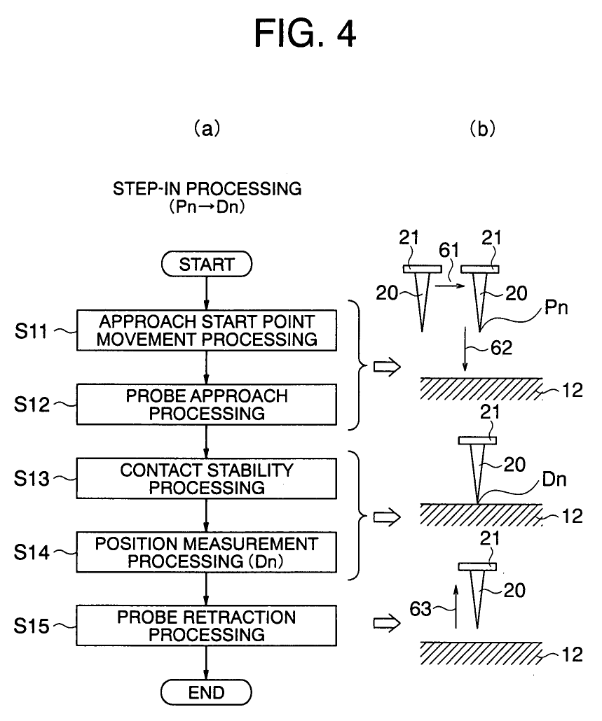

FIG. 5 A flow chart showing a typical embodiment of the method of control of a probe scan of a scanning probe microscope according to the present invention.

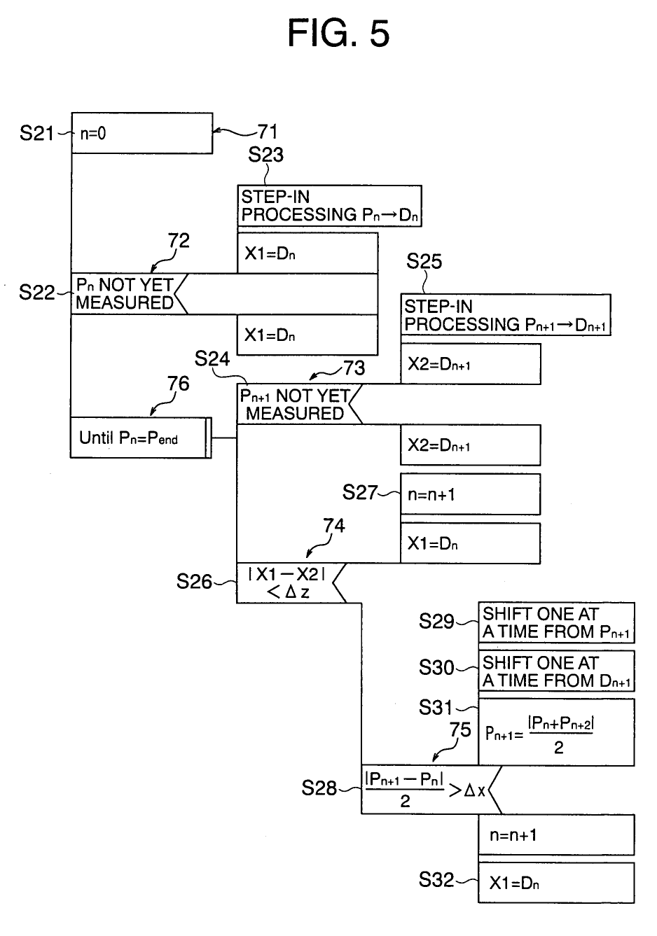

FIG. 6 A view of the configuration showing an embodiment of a control apparatus for working the method of control of a probe scan of a scanning probe microscope according to the present invention.

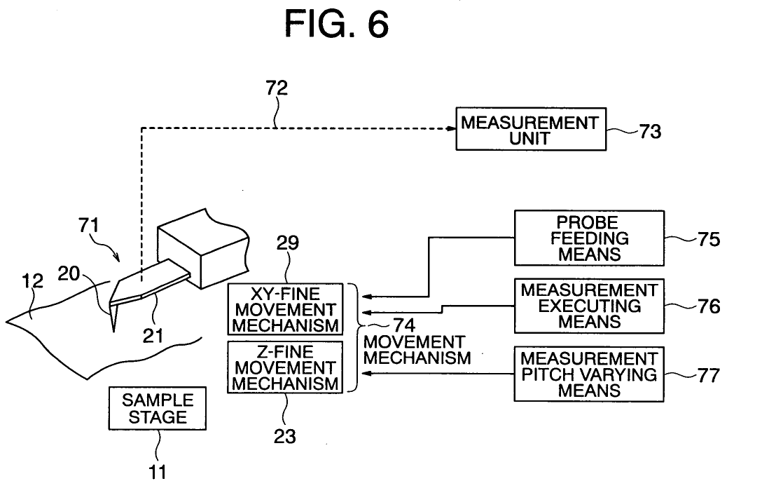

FIG. 7 A view showing another embodiment of the method of control of a probe scan according to the present invention and showing the scanning and measurement operation of a probe according to the step-in system.

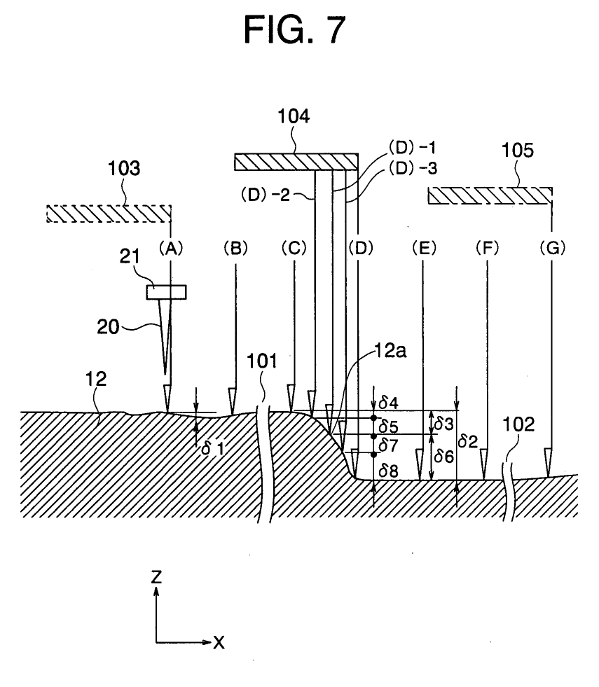

FIG. 8 A view for explaining a measurement operation (sampling operation) by a coarse movement stage step-in system at a scanning probe microscope.

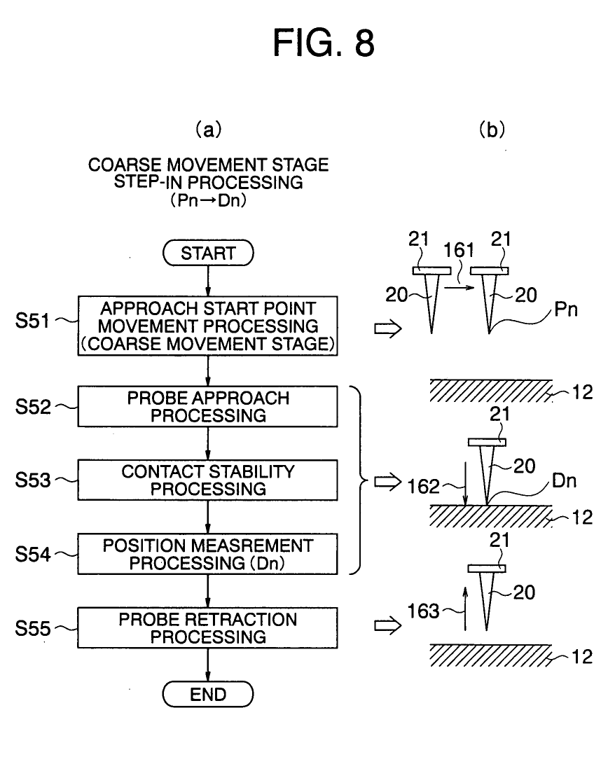

FIG. 9 A view for explaining a measurement operation (sampling operation) by a fine movement stage step-in system at a scanning probe microscope.

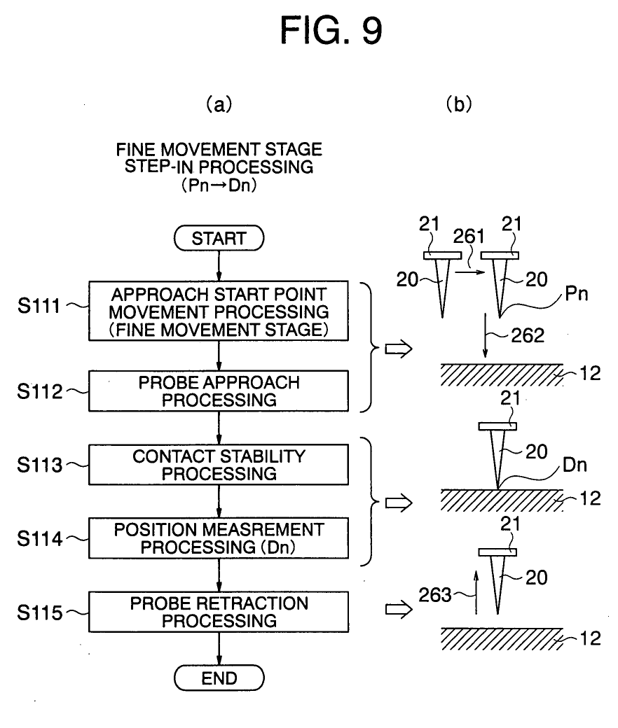

FIG. 10 A flow chart showing an embodiment of a method of control of a probe scan according to coarse movement stage step-in processing of a scanning probe microscope.

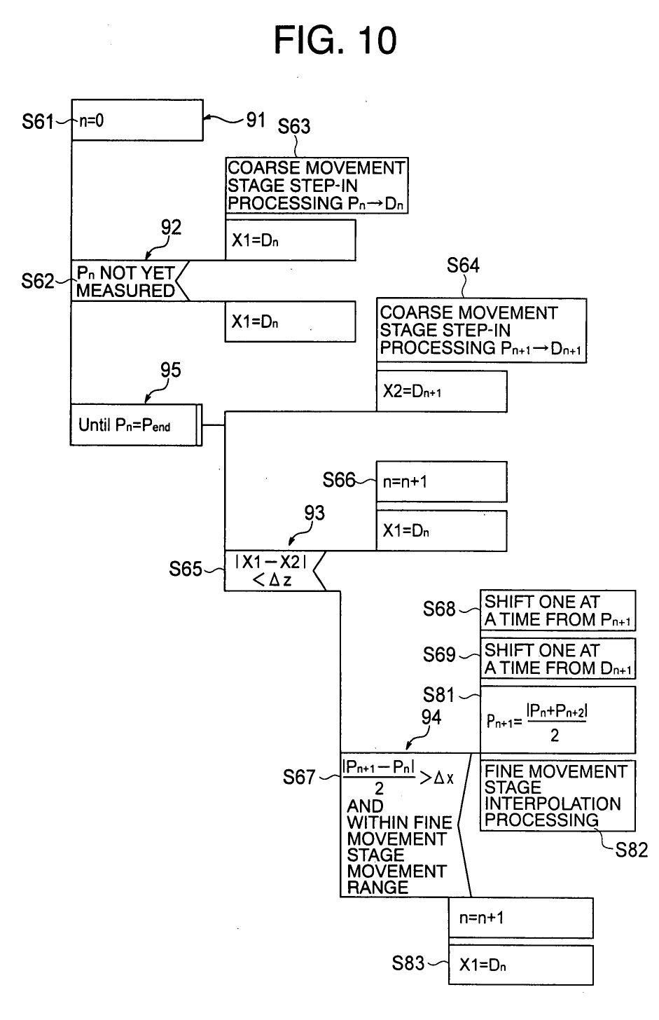

FIG. 11 A flow chart showing an embodiment of a method of control of a probe scan according to fine movement stage step-in processing of a scanning probe microscope.

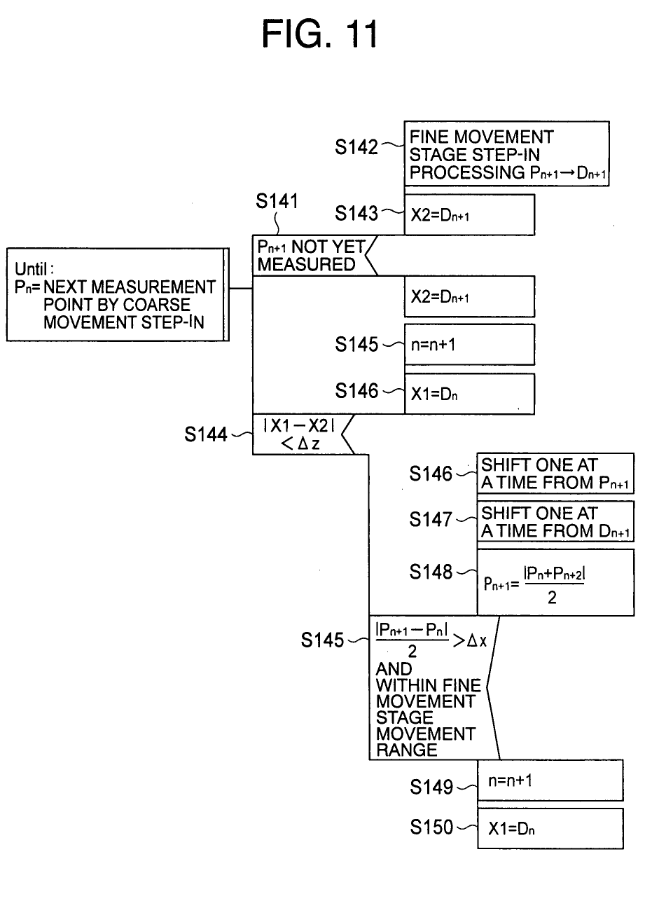

### DESCRIPTION OF NOTATIONS

11 sample stage
12 sample
16 sample holder
20 probe
21 cantilever
23 Z-fine movement mechanism
29 XY fine movement mechanism
33 controller
34 higher control apparatus

1. A method of control of a probe scan of a scanning probe microscope which is provided with a probe unit having a probe facing a sample, measurement units detecting a physical quantity occurring between said probe and said sample when said probe scans the surface of said sample and measuring surface information of said sample, and movement mechanisms changing the positional relationship between said probe and said sample and performing a scanning operation and which uses said movement mechanisms to scan the surface of said sample by said probe and uses said measurement units to measure the surface of said sample,
said method of control of a probe scan of a scanning probe microscope comprising,
a step of using said movement mechanisms to feed said probe by a certain distance in a direction along the surface of said sample at a position separate from said surface,
a step of using said movement mechanisms to make said probe approach said sample for measurement to obtain a measurement value at each of a plurality of measurement points determined by said certain distance then use said movement mechanisms to retract this,
a step of setting a new measurement point at a position between a first measurement point and an adjoining second measurement point when the difference between a measurement value at said first measurement point and a measurement value of said second measurement point is larger than a reference value, and
a step of moving said probe by said movement mechanisms to said new measurement point for measurement.

2. A method of control of a probe scan of a scanning probe microscope which is provided with a probe unit having a probe facing a sample, measurement units detecting a physical quantity occurring between said probe and said sample when said probe scans the surface of said sample and measuring surface information of said sample, and movement mechanisms changing the positional relationship between said probe and said sample and performing a scanning operation and which uses said movement mechanisms to scan the surface of said sample by said probe and uses said measurement units to measure the surface of said sample,
said method of control of a probe scan of a scanning probe microscope comprising,
a step of feeding said probe by a certain distance in a direction along the surface of said sample at a position separate from said surface,
a step of making said probe approach said sample for measurement to obtain a measurement value at each of a plurality of measurement points determined by said certain distance then retract this, and
a step of setting a new measurement point for measurement at a position between a certain measurement point and next measurement point when the difference between said measurement value at the certain measurement point and said measurement value of the next measurement point is larger than a reference value.

3. A method of control of a probe scan of a scanning probe microscope as set forth in claim 2 characterized in that the position between said certain measurement point and said next measurement point is a position determined by said intermediate value of a certain interval.

4. A method of control of a probe scan of a scanning probe microscope as set forth in claim 2 characterized by suspending the setting of said new measurement point when repeating measurement using positions between said certain measurement point and said next measurement point as new measurement points and the minimum width between measurement points becomes smaller than a predetermined value.

5. A method of control of a probe scan of a scanning probe microscope as set forth in claim 2 characterized by suspending the setting of said new measurement point when repeating measurement using positions between said certain measurement point and said next measurement point as new measurement points and the number of times of setting said new measurement point becomes larger than a predetermined value.

6. A method of control of a probe scan of a scanning probe microscope which is provided with a probe unit having a probe facing a sample, a detection unit detecting a physical quantity acting between said probe and said sample, a measurement unit measuring surface information of said sample based on said physical quantity detected by said detection unit when said probe scans the surface of said sample, a probe movement use movement mechanism having at least two degrees of freedom, and a sample movement use movement mechanism having at least two degrees of freedom and which uses said probe movement use movement mechanism or said sample movement use movement mechanism to change the relative positional relationship between said probe and said sample to make said probe scan the surface of said sample and uses said measurement unit to measure the surface of said sample,
said method of control of a probe scan of an scanning probe microscope comprising steps of,
performing measurement by a scan operation comprised of a step of using said sample movement use movement mechanism to feed said probe by a certain distance in a noncontact state with said sample, a step of making said probe approach said sample, a step of making said probe contact with said sample, and a step of making said probe retract from said sample and
operating said probe movement use movement mechanism when a certain contact position has a predetermined step difference value larger than the previous contact position in order to obtain a position between said certain contact position and said previous contact position for measurement in the scanning operation by said probe movement use movement mechanism.

7. A method of control of a probe scan of a scanning probe microscope as set forth in claim 6, characterized in that when said position between said certain contact position and said previous contact position is first an intermediate position of said certain distance at the feed operation and the step differences between the intermediate position and two ends of said certain distance are larger than said predetermined step difference value, the intermediate position is further obtained at the larger step difference side repeatedly until the step difference between the intermediate position and the two sides becomes smaller than a predetermined step difference value.

8. A method of control of a probe scan of a scanning probe microscope as set forth in claim 6, characterized by suspending the acquisition of said intermediate position when obtaining said intermediate position as the measurement point and the minimum width between measurement points is smaller than a predetermined value.

9. A method of control of a probe scan of a scanning probe microscope as set forth in claim 7, characterized by suspending the acquisition of said intermediate position when the number of times of obtaining the acquisition of said intermediate position becomes larger than a predetermined value.

10. A method of control of a probe scan of a scanning probe microscope as set forth in claim 6, characterized by continuing the feed operation of said sample movement use movement mechanism and operating said probe movement use movement mechanism.

11. A method of control of a probe scan of a scanning probe microscope as set forth in claim 6, characterized by suspending the feed operation of said sample movement use movement mechanism and operating said probe movement use movement mechanism.

12. An apparatus for control of a probe scan of scanning probe microscope which is provided with a probe unit having a probe facing a sample, a measurement unit measuring a physical quantity occurring between said probe and said sample when said probe scans the surface of said sample, and movement mechanisms changing the positional relationship between said probe and said sample and performing a scanning operation and which uses said movement mechanisms to scan the surface of said sample by said probe and uses said measurement unit to measure the surface of said sample,
said apparatus for control of a probe scan characterized by being provided with
a probe feeding means for feeding said probe by a certain measurement pitch in a direction along the surface of said sample at a position separate from said surface,
a measurement executing means for making said probe approach said sample for measurement to obtain a measurement value at each of a plurality of measurement points determined by said measurement pitch then retract this, and
a measurement pitch varying means for varying said measurement pitch between a certain measurement point and next measurement point to set a measurement point when the difference between a measurement value at said certain measurement point and a measurement value of said next measurement point is larger than a reference value.
